(19) United States
(12) Patent Application Publication
(10) Pub. No.: US 2007/0220671 A1
(43) Pub. Date: Sep. 27, 2007

(54) Method and apparatus for moving a patient

(75) Inventors: Patrick J. Vanderheiden, Aurora, NE (US); Fred C. Mohr, Marquette, NE (US); James A. Vanderheiden, Central City, NE (US)

Correspondence Address: VINCENT L. CARNEY LAW OFFICE, P.O. BOX 80836, LINCOLN, NE, 68501-0836, US

(73) Assignee: VanCare, Inc.

(21) Appl. No.: 11/389,966

(22) Filed: Mar. 27, 2006

(51) Int. Cl. A61G 7/10

(52) U.S. Cl. 5/81.1 R; 5/81.1 T

(57) ABSTRACT

A patient is moved into position on a turn sheet held with at least one turn sheet holder. The at least one turn sheet holder has at least one pair of jaw halves and lift means for moving said at least one turn sheet holder. The at least one turn sheet holder may grip a turn sheet and lift a portion of the turn sheet to move a patient laying on the sheet. The turn sheet holder includes at least one clamping actuator for forcing first and second jaw halves of the turn sheet holder together with a force provided by using no more than six turn sheet holders sufficient to hold said turn sheet while a patient weighing at least 50 pounds is moved by no more than six turn sheet holders. The turn sheet holder is adjustable to accommodate different thicknesses of turn sheets. The turn sheet is sufficiently strong to avoid tearing under said sufficient force to move a patient weighing at least 50 pounds when provided by using no more than six sheet holders.

### BACKGROUND OF THE INVENTION

This invention relates to methods and apparatus for moving a patient and more particularly to methods and apparatus for repositioning the patient such as by rolling the patient from one position to another.

It is known to move bedridden patients by using a turn sheet and a mechanical lift. The turn sheet is located under the patient and the mechanical lift is attached to the turn sheet by sheet holders. Two opposite sides of the turn sheet may be gripped by the sheet holders and the patient moved by the patient lift on the turn sheet. Additionally, the sheet holder may only grip one side of the turn sheet and lifter. In this case, the patient may be rolled onto his or her side or may be rolled over from front side to back side or back side to front side. If the patient is moved onto his or her side, he or she may be supported in that position by a pillow and cleaned, examined or treated or the sheet under him or her changed before the patient is rolled onto his or her other side for cleaning, examination or treatment or to change the sheet under the patient.

In one prior art type of apparatus for repositioning or moving a patient, the turn sheet has eyelets and the lift is equipped with an appliance that includes a strong frame having hooks spaced apart on it. The hooks on the lift are inserted into the eyelets and the lift repositions the patient. This prior art method and apparatus has the disadvantage of requiring special equipment such as special turn sheets with eyelets.

### SUMMARY OF THE INVENTION

Accordingly, it is an object of the invention to provide a novel method and apparatus for moving patients.

It is a further object of the invention to provide a novel method and apparatus for positioning immobile patients to provide care for them.

It is a still further object of the invention to provide a novel system for moving a patient on a turn sheet that is able to grip any sheet used as a turn sheet without special eyelets or other appliances on the turn sheet.

It is a still further object of the invention to provide a novel combination of a turn sheet, a turn sheet grip and a lift that can move at least a portion of the turn sheet to move a patient.

It is a still further object of the invention to provide a novel turn sheet holder that grips a turn sheet with at least one pair of jaw halves.

It is a still further object of the invention to provide a novel patient turning method and apparatus that spreads the stress on a turn sheet over sufficient distance to avoid tearing of the turn sheet.

It is a still further object of the invention to provide a novel turn sheet grip that exerts force over a sufficient area to provide a comfortable level of support when turning a patient.

It is a still further object of the invention to provide a turn sheet holder that is adjustable to accommodate different thicknesses of turn sheets.

It is a still further object of the invention to provide a turn sheet holder with a coefficient of friction between the engaging surfaces sufficient to avoid slipping of the turn sheet when used to move a load of more than 800 pounds.

In accordance with the above and further objects of the invention, a patient is moved such as by repositioning or rolling or tuning the patient over with a patient lift or other type of lift while the patient is on a turn sheet held with at least one turn sheet holder. The at least one turn sheet holder has at least one pair of jaw halves and a clamping actuator for clamping the two jaw halves of the turn sheet holder together. The at least one turn sheet holder may grip a turn sheet and pull at least a portion of the turn sheet to move a patient.

To reduce the number of incidents in which a turn sheet is torn or slips, the jaw halves each have a frictional surface positioned to meet the frictional surface of the other jaw half to grip a turn sheet with an appropriate force, over an appropriate area having appropriate length and width dimensions. In this specification, the term “frictional surface” includes any surface designed to grip a turn sheet to be lifted and hold it frictionally in contrast to holding the sheet or other object with gripping eyelets or other openings in which the edge of the opening bears the lifting force rather than the portion of the sheet or other object between the gripping surfaces. The term “sheet” in this specification includes ordinary sheets such as are in general usage even outside of patient care, turn sheets, draw sheets or any other flexible sheet like article that can be gripped by sheet holders and used to reposition or turn patients.

To reduce the incidents in which the turn sheet slips, the turn sheet holder includes at least one clamping actuator for forcing first and second jaw halves of the turn sheet holder together with a non-slip force. In this specification, the term “non-slip force” means a force sufficiently large to create frictional resistance on the object between the frictional surfaces of the jaw halves to prevent slipping in normal patient-moving use.

To reduce the incidents in which a turn sheet is torn, the jaw halves each have a tear resistant length. In this specification, the term “tear-resistance length” means length of the meeting portions of the jaw halves orthogonal to the force applied to the sheet or other object being gripped in normal patient repositioning use. In this specification, the term “normal patient-repositioning use” means gripping a turn sheet with two spaced apart turn sheet holders with a patient weighing between 50 and 800 pounds on the turn sheet and at least partly turning the patient over or moving or repositioning the patient. For purposes of this definition, the turn sheet is assumed to be in average condition and not unusually degraded in any manner. The above definitions are not intended to limit the scope of the invention except when used specifically for that purpose and the invention can be used other than for normal patient-repositioning use.

In the preferred embodiment, the clamping actuator provides mechanical advantage to the force applied by the person operating the patient lift to increase the force to a non-slip force on the sheet or other object. Preferably, the force is adjustable. In the preferred embodiment, the mechanical advantage is obtained from an adjustable lever arrangement that moves a camming surface to force the two jaw halves together. With this arrangement, the turn sheet holder is adjustable to accommodate different thicknesses of turn sheets. For example, the turn sheet may be folded several times at the end to take up surplus length and the holding means can be adjusted to grip the folded sheet.

From the above description, it can be understood that this invention has several advantages, such as: (1) it does not require a special type of turn sheet or the like and can be utilized with the standard draw sheets commonly in use in hospitals and nursing homes; (2) it distributes the force along a sufficient pulling length of a turn sheet to avoid separation of the turn sheet such as by tearing; (3) it sufficiently grips the turn sheet to prevent slipping; (4) it can be used with turn sheets that extend a substantial distance beyond the patient; and (5) it is readily adaptable to any type of turn sheet and to a multiplicity of thicknesses and conditions of turn sheets.

### BRIEF DESCRIPTION OF THE DRAWINGS

The above noted and other features of the invention will be better understood from the following detailed description when considered in connection with the accompany drawings in which:

FIG. 1 is a perspective view of a patient, an attendant and lift for moving the patient in accordance with an embodiment of the invention;

FIG. 2 is a perspective view of one embodiment of a clip or holder used in the embodiment of FIG. 1;

FIG. 3 is an exploded perspective view of the clip or holder of FIG. 2 having first and second jaw halves;

FIG. 4 is a front elevational view of the second jaw half taken through lines 4-4 of FIG. 3;

FIG. 5 is a side elevational view of the second jaw half taken through lines 5-5 of FIG. 4;

FIG. 6 is an exploded top view, partly broken away of the second jaw half taken along lines 6-6 of FIG. 4;

FIG. 7 is a sectional view of the second jaw half taken along lines 7-7 of FIG. 4;

FIG. 8 is a front elevational view of the first jaw half taken along lines 7-7 of FIG. 3;

FIG. 9 is a side elevational view of the first jaw half taken through lines 9-9 of FIG. 8;

FIG. 10 is a top view of the first jaw half taken through lines 10-10 of FIG. 8;

FIG. 11 is a sectional view of the first jaw half shown taken along lines 11-11 of FIG. 8;

FIG. 12 is an exploded perspective view of another embodiment of clip holder similar to the embodiment of FIG. 3;

FIG. 13 is a side elevational view of a first jar half similar to the jaw half of FIG. 5 but in accordance with the embodiment of FIG. 12;

FIG. 14 is a perspective of one embodiment of insert usable in the embodiment of FIG. 12;

FIG. 15 is another embodiment of insert usable in the embodiment of FIG. 12

FIG. 16 is a side elevational view of a clamping actuator that is part of the turn sheet holder of FIG. 3; and

FIG. 17 a plan view of the clamping actuator of FIGS. 2 and 3.

### DETAILED DESCRIPTION

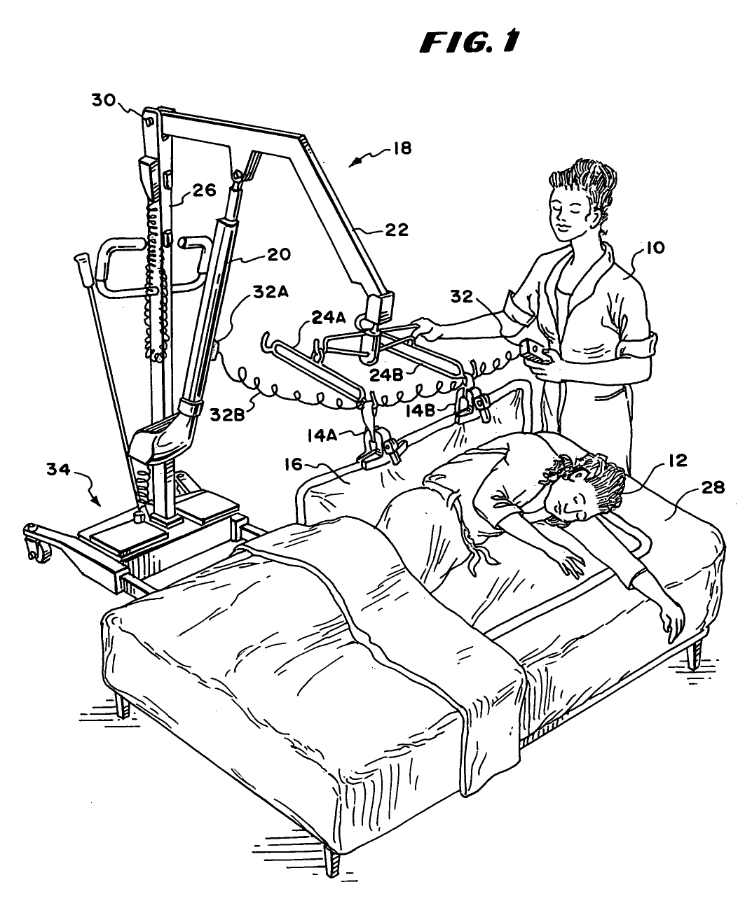

In FIG. 1, there is shown a simplified perspective view of a patient 12 on a bed 28 being moved on a turn sheet 16, one end of which is held by holders 14A and 14B. The holders 14A and 14B are mounted to a lift 18 that may raise or lower the end of the turn sheet 16 under the control of an attendant 10. The attendant may for example use the lift 18, turn sheet 16 and turn sheet holders 14A and 14B to roll the patient on one side or turn the patient over. With this arrangement, any lift 18 may conveniently reposition a patient up under the control of a hand-held control unit 32 so that supports can be put under the patient to permit access to the underside of the patient. The lift 18 is preferably mobile and can be moved from position to position on its base 34 or may be moved on overhead rails that are structurally part of some buildings or by any other convenient conveyance. The holders 14A and 14B may release the turn sheet 16 and fasten to another end of a turn sheet since the turn sheet does not require any special eyelets or the like for engagement in the holders 14A and 14B.

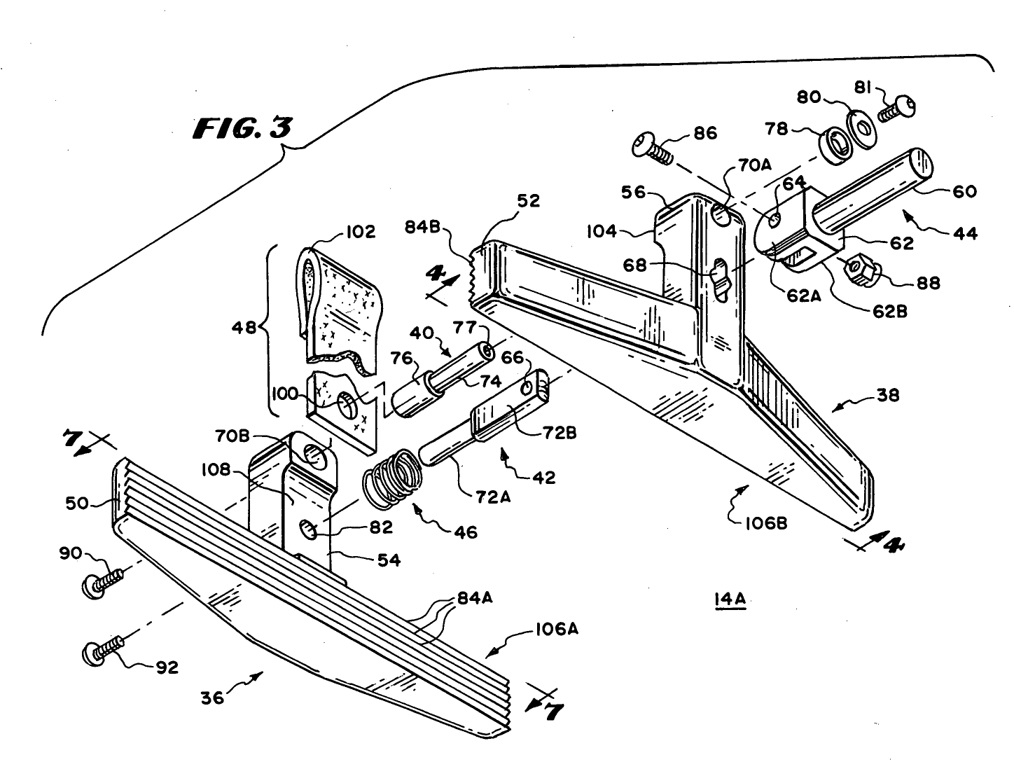

While the lift may be of any particular type, the lift 18 shown in FIG. 1 is a lift available from VanCare, Inc., 1515 First Street, Aurora, Nebr. 68818 under the designation Vander-Lift-600. The holders 14A and 14B are easily connectable to lift fastener 48 (FIG. 3) for mounting to the lift. Such lifts are in common use in nursing homes and hospitals, generally with four locations to which a holder may be mounted. The four locations are usually used for the four corners of a lift chair or the like but two such mounting locations may conveniently be used for two holders to move one end of the draw sheet. Because the holders are easily released and the lifts are generally mobile, the lift may be moved to either side of a bed and conveniently lift either side of a turn sheet to reposition or roll a patient in either direction.

The lift 18, like many types of lifts on the market, includes a boom or arm such as that shown at 22 and mounting hooks such as those shown at 24A and 24B that are parallel to each other. The boom 22 is hinged in the embodiment of FIG. 1 by a hinge 30 to a stand 26. An hydraulic cylinder 20 is controlled by the convenient hand-held control unit 32 to raise or lower the holders 14A and 14B. The hand held control unit 32 is operated to control a pump control unit by electrical connectors 32A and 32B. The turn sheet 16 does not have eyelets or other special appliances but may be an ordinary sheet or turn sheet. Herein, the ordinary sheet or turn sheet will be referred to usually by the term “sheet” but is understood to be any ordinary sheet. Actually even the special sheets with eyelets may be used but are unnecessary for the proper use of this invention.

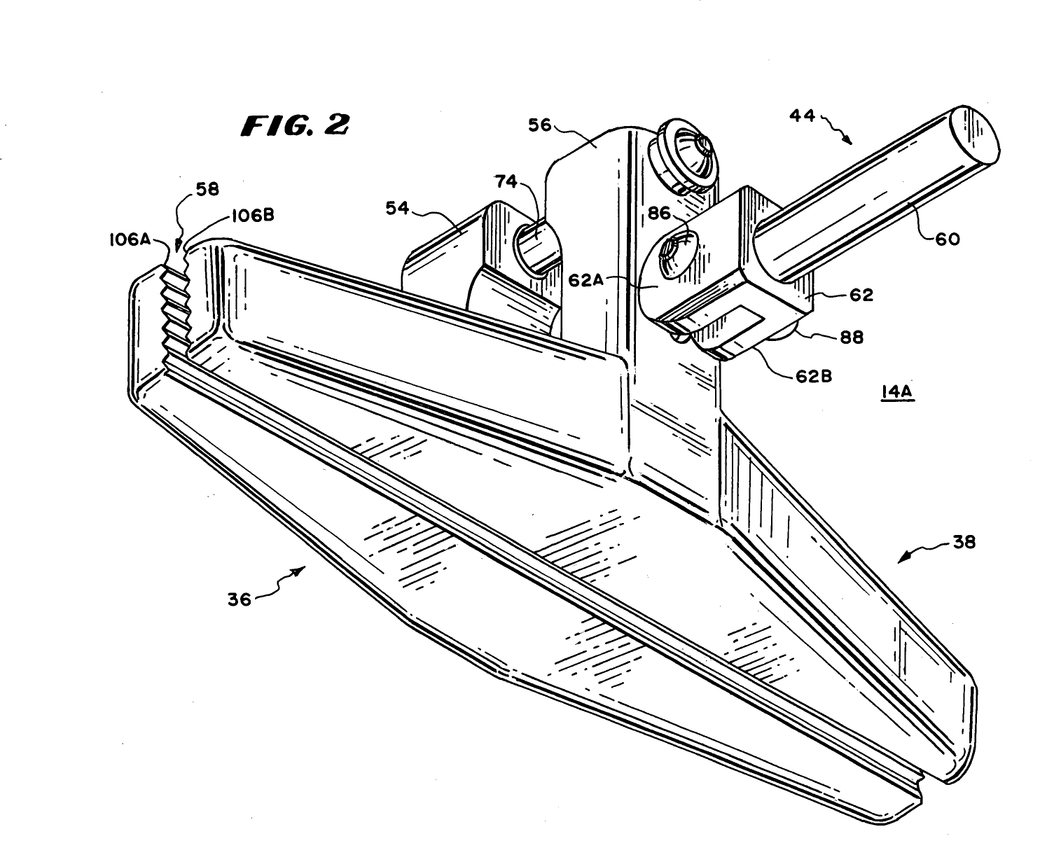

In FIG. 2, there is shown a perspective view of a holder or clip 14A having a clamping actuator 44, a first jaw half 36 and a second jaw half 38 with the jaw halves having gripping surfaces facing each other to form the sides of an opening 58 between the first jaw half 36 and the second jaw half 38. The jaw halves 36 and 38 each have a corresponding one of frictional surfaces 106A and 106B positioned to meet the frictional surface of the other jaw half to grip a turn sheet 16 (FIG. 1). In this specification, the term “frictional surface” include any surface designed to grip a turn sheet to be lifted and hold it frictionally in contrast to holding the sheet or other object with gripping eyelets or other openings in which the edge of the opening bears the lifting force rather than the portion of the sheet or other object between the gripping surfaces.

The first jaw half 36 and the second jaw half 38 cooperate together and with the clamping actuator 44 to clamp the edge of the turn sheet 16 (FIG. 1) while the lift fastener 48 (FIG. 3) connects the holders, clips or clamps 14A and 14B and thus the edge of the turn sheet 16 to the lift 18 by engaging the lift hooks 24A and 24B (FIG. 1). The clamping actuator 44 is able to force the first and second jaw halves 36 and 38 together with sufficient gripping force to turn a heavy patient such as for example an 800 pound patient up on the patient's side (moving the center of gravity over the patient's median plane so that it is centered in a vertical plane passing through the patient). The gripping force should be spread out over a length of the turn sheet so that the tensile force is spread out over the turn sheet to prevent tearing. The clamping actuator 44 provides mechanical advantage to the force and is adjustable. It does this with an adjustable lever arrangement that moves a camming surface on gudgeon sides 62A and 62B with a lever handle portion 60 to force the two jaw halves 36 and 38 together.

To provide the ability to pull against substantial force without tearing a turn sheet or ordinary sheet or other object, the jaw halves 36 and 38 each have a tear resistant length. In this specification, the term “tear-resistance length” means length of the meeting portions of the jaw halves orthogonal to the force applied to the sheet or other object being gripped in normal patient-repositioning use. In this specification, the term “normal patient-repositioning use” means gripping a turn sheet with two spaced apart turn sheet holders with a patient weighing between 50 and 800 pounds on the turn sheet and moving the patient or turning the patient over. For purposes of this definition, the turn sheet is assumed to be in average condition and not unusually degraded in any manner.

With this arrangement, the turn sheet holder is adjustable to accommodate different thicknesses of turn sheets. For example, the turn sheet may be folded several times at the end to take up surplus length and the holding means 14A and 14B can be adjusted to grip the folded sheet for forcing first and second jaw halves 36 and 38 of the turn sheet holder together with a non-slip force. In this specification, the term “non-slip force” means a force sufficiently high to create frictional resistance on the object between the frictional surfaces of the jaw halves to prevent slipping in normal patient-repositioning use.

The turn sheet may, under some circumstances, be gripped at a thickened portion or a portion folded over so that sufficient force can be provided. A long sheet which cannot be gripped at its very edge can be accommodated by gripping the turn sheet at a folded portion that is folded to form an edge. In the preferred embodiment, the lift 18 (FIG. 1) is designed to lift 600 pounds but other lifts with greater lifting capacity may be used. While a toggle comprising the gudgeon sides 62A and 62B of a gudgeon 62, the handle 60 of the clamping actuator 44 form the toggle in the embodiment of FIG. 2, many other clamping actuators are known in the art such as for example, screw drives or wedging devices can be used. The above definitions are not intended to limit the scope of the invention except when used specifically for that purpose and the invention can be used other than for normal patient-repositioning use.

In FIG. 3, there is shown an exploded perspective view partly broken away of the holder 14A and a lift fastener 48 for mounting the holder or clip 14A to a hook such as shown at 24A and 24B (FIG. 1). In the preferred embodiment, the lift fastener 48 is a looped strap that includes a hole 100, and a loop 102. The hole 100 receives a smaller cylindrical end 74 of a shaft 40 and the loop 102 receives a hook such as 24A (FIG. 1) to mount the holder or clip 14A to the lift 18 (FIG. 1). The holder 14A includes the first and second jaw halves 36 and 38, a shaft 40, a holder shaft 42 and the clamping actuator 44.

The first jaw half 36 includes a first jaw head 50 and a first jaw spline 54. The first jaw head 50 includes a plurality of parallel elongated jaw teeth 84A on the friction surface 106A that engage similar jaw teeth 84B on the friction surface 106B in a second jaw head 52 of the second jaw half 38 to firmly grip the edge of the turn sheet 16 (FIG. 1). While a plurality of engaging jaw teeth are shown in FIG. 3, other gripping arrangements may be used such as high friction large area flat surfaces that engage the sheet or even a plurality of finely pointed members forming matrices on each head that move together. It is only necessary for there to be adequate gripping force to turn a heavy patient such as for example an 800 pound patient up on the patient's side (moving the center of gravity over the patient's median plane so that it is centered in a vertical plane passing through the patient). The gripping force should be spread out over a length of the turn sheet so that the tensile force is spread out over the turn sheet to prevent tearing. The turn sheet may be gripped at a thickened portion or a portion folded over so that sufficient force can be provided. A long sheet which cannot be gripped at its very edge can be accommodated by gripping the turn sheet at a folded portion that is folded to form an edge.

The spline 54 of the first jaw half 36 extends downwardly from a central portion of the first jaw head 50 and has within its downwardly extending portion a bore 82 for receiving one end of the holder shaft 42 and a shaft opening 70B for receiving a larger cylindrical end 76 of the shaft 40. The second jaw half 38 has a plurality of parallel jaw teeth 84B positioned to engage the teeth 84A of the first jaw half 36 and a spline 56 with a first opening 68 for receiving the end 72B of the shaft 42 and an opening 70A for receiving the smaller cylindrical end 74 of the shaft 40.

To bias the heads of the first and second jaw halves 36 and 38 apart, the shaft 42 includes a parallelopiped portion 72B and a cylindrical portion 72A integral with each other and end to end. The cylindrical portion 72A has a diameter smaller than any side of the parallelopiped portion 72B and is adapted to receive a helical compression spring 46, which abuts the larger parallelopiped portion 72B on one of its ends and a flat surface of the jaw spline 54 on its other end. The end of the cylindrical portion 72A passes through the bore 82 in the jaw spline 54 and receives a bolt 92 within a tapped opening in its end. The head of the bolt 92 is too large to pass through the bore 82 and thus holds the cylindrical portion 72A within the bore 82 with the compression spring 46 between the spline 54 and the end of the parallelopiped portion 72B to bias the parallelopiped portion 72B away from the spline 54. The jaw spline 56 includes the opening 68 through which the end of the parallelopiped portion 72B passes.

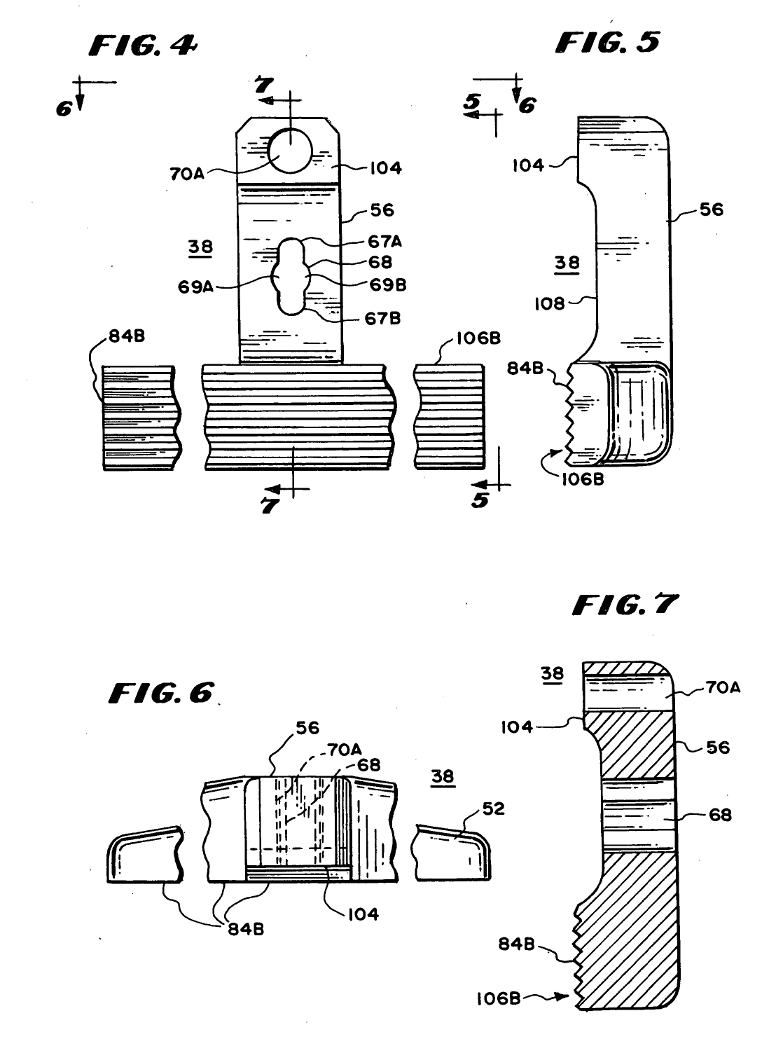

The parallelopiped portion 72B extends to a location between the gudgeon sides 62A and 62B where its opening is aligned with a gudgeon pin opening 64 of the gudgeon 62 so as to pivotally mount the clamping actuator 44 to the holder shaft 42. The parallelopiped portion 72B has a gudgeon hole passing through its flat ends as shown at 66 to receive a gudgeon pin 86 to hold the parallelopiped portion 72B within the opening 68. With this arrangement, the shaft 42 and camming surfaces on the ends of gudgeon sides 62A and 62B move the first and second jaw halves 50 and 52 together against the pressure of the compression spring 66 as explained below. When the parallelopiped portion 72B is pulled through the elongated opening 68 and the cylindrical portion 72A of the holder shaft 42 is within the central portion 69A and 69B (FIG. 4), the shaft can be turned to cause its edge to rest on the outside of the splice 56. This locks the first and second jaw halves together in a self locking position.

To clamp the two friction surfaces 106A and 106B together to hold a turn sheet 16 (FIG. 1) with a non-slip force, the clamping actuator 44 includes the cylindrical handle portion 60 and the gudgeon portion 62 having the parallel spaced apart gudgeon sides 62A and 62B within them aligned with the gudgeon pin opening 64 extending thereto perpendicular to the handle 60. The gudgeon pin 86 passes through the opening 64 to permit rotary motion of the clamping actuator 44 thereabout and is held in place by a nut 88.

To provide stability to the clamping and releasing movement of the first and second jaw halves 36 and 38 and to connect the lift 18 (FIG. 1) to the holders 14A and 14B with the lift fastener 48, the first and second jaw splines 54 and 56 include corresponding shaft opening 70B and cylindrical opening 70A respectively. The shaft 40 includes two cylindrical portions: a larger cylindrical end 76 that fits within the shaft opening 70B in the first jaw spline 54 and a smaller cylindrical end 74 that passes through the first opening 70A in jaw spline 56. The smaller cylindrical end 74 receives a bushing bearing 78 over it within the opening 70A and a washer 80 outside of the spline 56. The smaller cylindrical end 74 includes a tapped hole 77 on it which receives a screw 81 to be threaded into it and holds the washer 80 against the opening 70A with the bushing bearing 78 within the cylindrical opening 70A of the spline 56. The larger cylindrical end 76 of the shaft 40 passes through the opening 70B of the spline 54 and is held in place by a bolt 90. Similarly, the smaller cylindrical portion 74 of the shaft 40 extends through the opening 70A of the spline 56 and has a tapped hole 77 on its end. The tapped hole 77 receives the screw 81 that holds the bushing 80 against the spline 56 while the bushing bearing 78 extends into the opening 70A in the spline 56 to permit the splines 56 and 54 to move apart and together as the turn sheet 16 (FIG. 1) is compressed or released between the jaw teeth 84A and 84B.

In FIG. 4, there is shown a front elevational view of one embodiment of the second jaw half 38 having the teeth 84B extending parallel to each other across the length of the jaw and having the jaw spline 56 with the opening 68 for the holder shaft 42 (FIG. 3) and the opening 70A through which the smaller cylindrical end 74 of the shaft 40 extends. The opening 68 includes a longitudinal axis with curved end portions 67A and 67B. The length of the opening 68 in the preferred embodiment is 0.730 inches. The radius of the longitudinal end portions 67A and 67B is 0.260 inches. In the center of the longitudinal axis is a bulge formed by orthogonally extending curved portions 69A and 69B having a radium of curvature of 0.359 inches. The radius of the opening 70A is 0.406 inches. The width of the spline 56 is one inch and its total length is 2.35 inches. The opening 68 has its longitudinal center spaced 1.5 inches from the bottom of the spline 56 and it is centered along its median. The center of the opening 70A is 0.3 inches from the bottom and its radius is 0.406 inches.

More specifically, the length of the opening 68 and its narrowest width at its end portions accommodates the right parallelopiped portion 72B of the holder shaft 42 (FIG. 3). The central portion accommodates the smaller cylindrical portion 72A of the holder shaft 42 (FIG. 3). With this arrangement, when the clamping actuator handle 60 (FIG. 3) is pulled into alignment with the longitudinal axis of the holder shaft 42, the gudgeon side members 62A and 62B of the gudgeon 62 (FIG. 3) push against the spline 56 because the distance to the curved edge of the side members 62A and 62B from the center of the gudgeon pin opening 64 (FIG. 3) is longer along the longitudinal axis of the holder shaft 42 than in the transverse direction to the straight edges of the side members 62A and 62B (FIG. 3). Because of the mechanical advantage provided by the lever action of the holder shaft 42 (FIG. 3), significant force is exerted to pull the holder shaft 42 (FIG. 3) back into the opening 68 to press the teeth 84A and 84B into each other and thus grip the turn sheet 16 (FIG. 1) with sufficient force to move the patient.

In FIG. 5 there is shown a side elevational view of the second jaw half 38 taken through lines 5-5 of FIG. 4 showing the spline 56 with a raised portion 104 and a narrower portion 108 positioned to meet with a raised portion 110 (FIG. 3) of the spline 54 of the first jaw half 36 (FIG. 3).

In FIG. 6, there is shown a top view, partly broken away of the second jaw half 38 taken in the direction of lines 6-6 of FIG. 4 having the jaw spline 56 with the opening 68 shown in hidden lines passing there through and the shaft opening 70A sized to receive the smaller cylindrical end 74 of the shaft 40 (FIG. 3). At its narrowest point, as shown in this view, the top of the jaw head 52 is 0.438 inches at its outer extremities and at its widest view the top is one inch. The total length of the jaw head 52 is eight inches. With the alignment of the two openings 68 and 70A and shafts 42 and 40 (FIG. 3), the second jaw half 38 is maintained in alignment and moved to and from the first jaw half 36 (FIG. 3). The total length of the turn sheet holders or holders holding a turn sheet during normal patient-repositioning use should be between 10 and 30 inches.

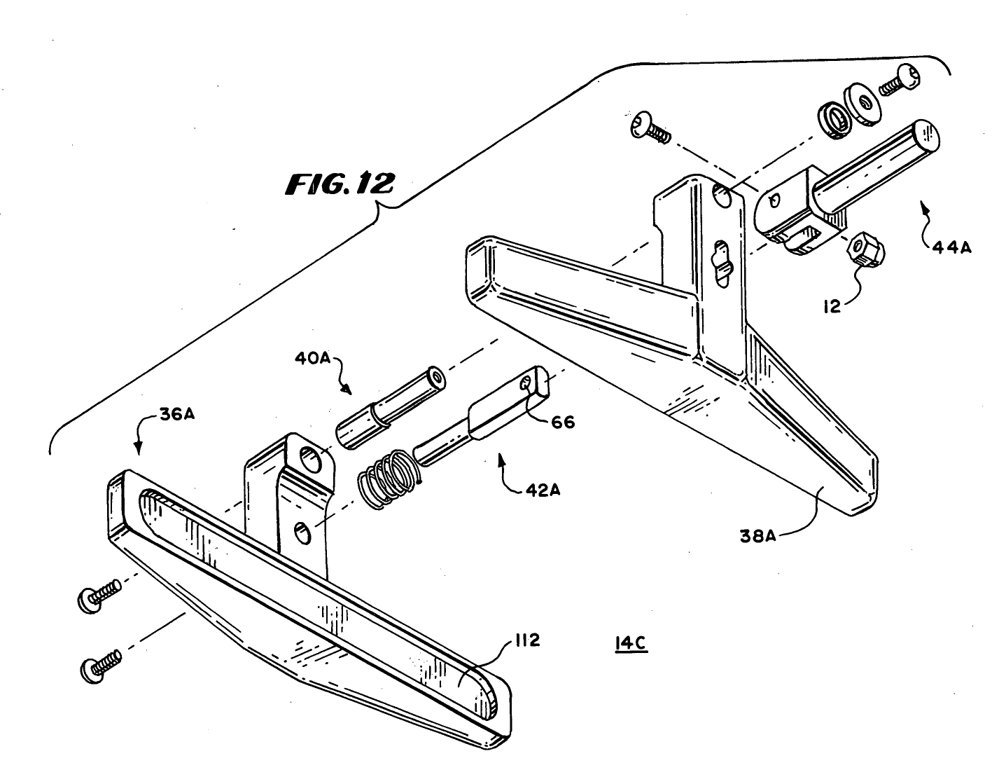

In FIG. 7, there is shown a side elevational view of the second jaw half 38 taken along lines 7-7 of FIG. 4 with the vertically aligned lever opening 68 and the shaft opening 70A that permit movement back and forth with the first jaw half 36 (FIG. 3) while remaining aligned so that the teeth 84A and 84B of the first and second jaw halves 36 and 38 clamp together with the turn sheet 16 (FIG. 1) between them. To permit engagement over the entire area of the teeth, a raised portion 104 and the teeth 84B extend toward the corresponding parts of the first jaw half 36 (FIG. 3) substantially the same distance to maintain the surfaces level when engaged on opposite sides of the turn sheet 16 (FIG. 1). As shown in this view, the recessed portion of the second jaw half 38 at the inner center facing the teeth 84A of the first jaw half 36 have radiuses extending down to a 0.710 thinness at the center with the radiuses being 0.375 inches. The teeth 84B face outwardly to engage the teeth 84A of the first jaw half 36 of the holder 14A (FIGS. 2 and 3). The angle of the teeth 84A and 84B is 45 degrees from the vertical and 45 degrees from the horizontal to form a relatively sharp point although other amounts of engaging surface may be utilized as well. As mentioned earlier, the engaging surfaces 106A and 106B need not be teeth extending parallel to the direction of the force on the turn sheet as in the embodiment of FIGS. 7 and 11 but can have other shapes to hold the turn sheet such as flat or matrix or roughed.

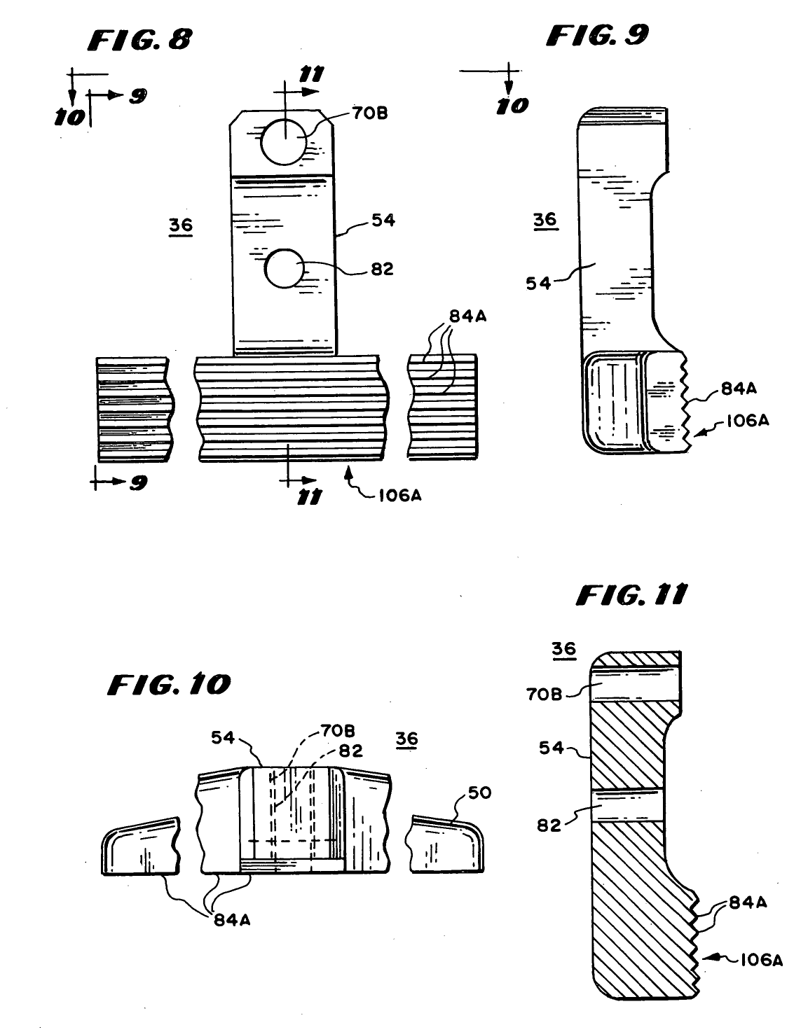

FIGS. 8, 9, 10 and 11 are respectively front elevational, side elevational, top, and sectional view of the first jaw half 36 and have parts similar to those of the second jaw half 38 with which it cooperates except that the openings 82 and 70B in the first jaw half 36 are not the same as the corresponding openings 68 and 70A in the second jaw half 38. As shown in this view, the opening 82 has a 3/16 inch through borer and a 5/16 inch counter borer 0.570 inches deep to receive the smaller end portion 72A of the shaft 42 (FIG. 3) and the opening 70B has a through borer of 3/16 inch with a ⅜ inch counter borer 0.700 inches deep to receive the end 76 of the shaft 40 (FIG. 3). The first jaw half 36 cooperates with the second jaw half 38 to form a holder that is biased open but may be closed to clamp on a turn sheet 16 (FIG. 1) with great force by means of the clamping actuator 44 (FIG. 3) which exerts pressure at the ends of the gudgeon 62 (FIG. 3) against the face of the spline 56 (FIG. 3) with leverage from the handle 60 (FIG. 3) being sufficient to provide an adequate distributed force for a draw sheet, even if the turn sheet has been weakened by laundering. A shorter lever could be used without requiring excessive force if the area were increased and if the area were decreased then greater force would be likely to be necessary. Also the force is varied by the nature of the surfaces of the jaw heads.

In FIG. 12, there is shown an exploded perspective view, partly broken away of another embodiment of holder 14C similar to the holders 14A and 14B (FIG. 1) having a first jaw half 36A, a second jaw half 38A, a shaft 40A, a holder shaft 42A and a clamping actuator 44A. These parts cooperate together in the same manner as the corresponding parts 36, 38, 40, 42 and 44 of FIG. 3 to clamp a turn sheet along its edge. However, instead of the integrally formed surfaces with jaw teeth such as the jaw teeth 84A and 84B (FIG. 3), the first and second jaw halves 36A and 38A permit selected inserts to be inserted into recesses such as the recess 112 in the first jaw half 36A. The second jaw half 38A has an identical recess. These recesses are adapted to receive inserts chosen for the particular circumstance and may for example be silicon inserts. They create frictional surfaces similar to those created by the jaw teeth 84A and 84B in the embodiment of FIG. 3.

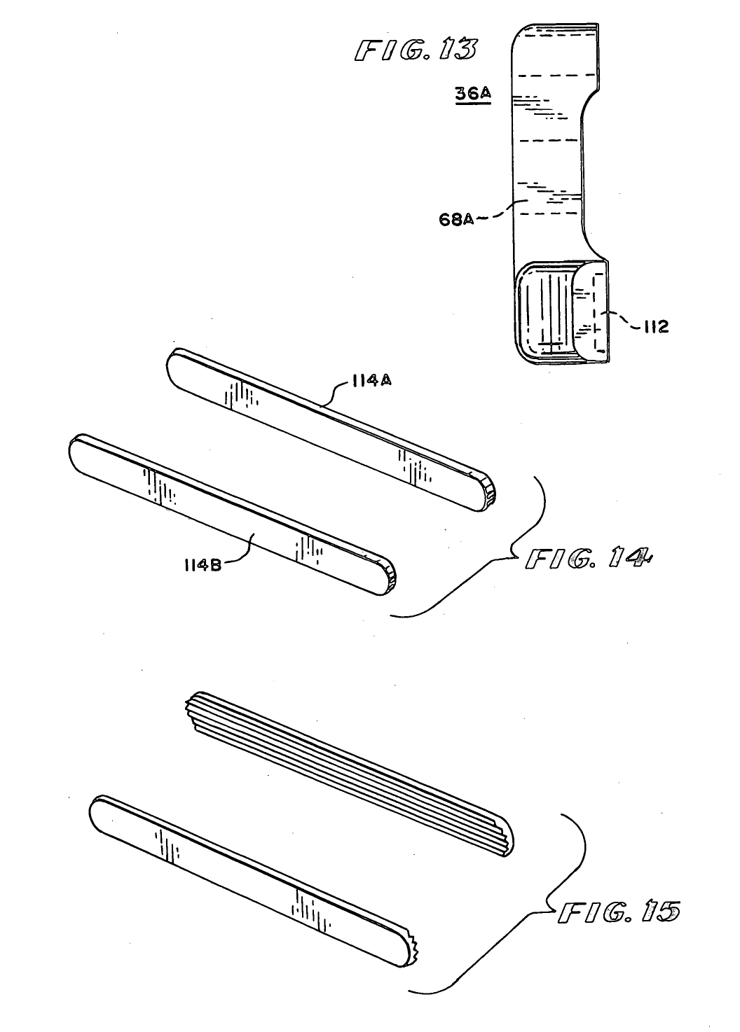

In FIG. 13, there is shown a elevational view of the first jaw half 36A having the recess portion 112 and the central opening 68A in a manner similar to the embodiment of FIG. 9. As shown in FIGS. 14 and 15, different shaped inserts of different materials may be provided to fit conformably into the recess such as that shown at 112. In FIG. 14, two such inserts made of silicone are shown with the insert 114A being fitted into the recess 112 and the insert 114B being fitted into the identical recess in the second jaw half 38A. In the preferred embodiment, the inserts are 7⅜ inches long, ¾ inch wide and a ¼ inch thick. They are fitted into recesses such as the recess 112 so that a portion of them extends above the outer edge of the recess so that it may be compressed to exert frictional force on the turn sheet. In the preferred embodiment, it extends approximately ⅛ inch above the recess in the first and second jaw halves but the amount is selected for maintaining frictional forces in accordance with the material used and its shape. The compressibility of the material and its resistance to wear for example may lead to a different thickness of insert. In FIG. 15, another insert of similar size is shown but having jaw teeth extending outwardly in a manner similar to that of the embodiment of FIG. 3.

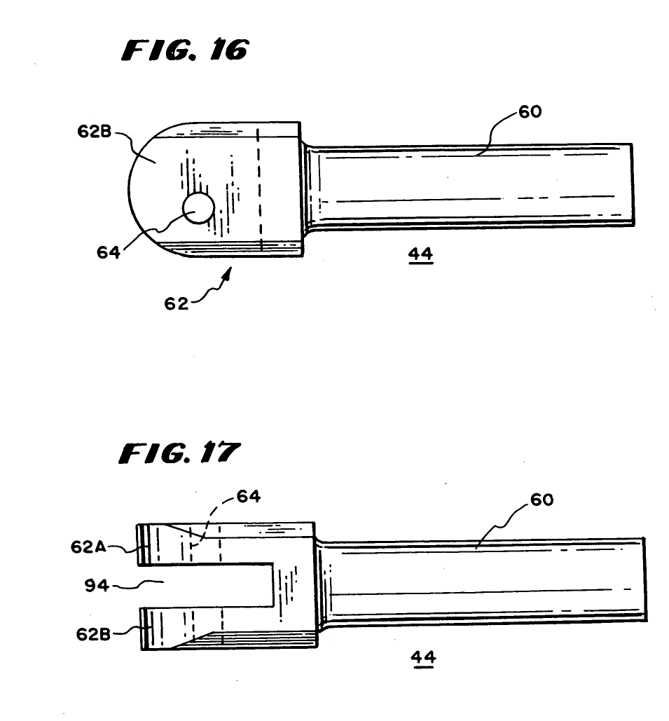

In FIGS. 16 and 17 respectively, there are shown a side elevational view and a plan view of the clamping actuator 44 having the cylindrical lever handle portion 60, the gudgeon 62 with the two gudgeon sides 62A and 62B and the gudgeon pin opening 64. As shown in this view, the total length of the gudgeon 62 and handle 60 is 3.062 inches in the preferred embodiment with the gudgeon 62 being 1.062 inches long and the cylindrical handle 60 being two inches long. The gudgeon sides 62A and 62B have a width of 0.82 inches and the radius of the gudgeon pin opening 64 is 3/16 inches and it is positioned 0.41 inches from the outer tip of the gudgeon sides 62A and 62B. As shown in FIG. 17, the gudgeon 62 includes an opening 94 between the gudgeon sides 62A and 62B. The gudgeon opening 94 is 0.255 inches and the width of each of the gudgeon sides 62A and 62B is 0.25 inches with an end camphor extending outwardly for ease in inserting the parallelopiped end 72B of the holder shaft 42 (FIG. 3).

In use, the patient lift 18 (FIG. 1) grips a turn sheet 16 (FIG. 1) without eyelets or other appliances. The patient lift 18 includes clips or holders 14A and 14B that hold the turn sheet 16 with enough force to turn the patient 12 or lift the patient 12 and is able to apply that force while avoiding tares or slipping better than patient lifts that rely on turn sheets with eyelets or the like. While the sheet or turn sheet 16 is gripped, the patient may be repositioned such as on his or her back, or temporarily positioned for cleaning the patient's back or to change sheets under the patient using the patient lift 18.

To enable the patient lift 18 to grip a turn sheet 16, the patient lift 18 is brought close to the patient's bed 28 (FIG. 1). Generally, such lifts include rollers on a base 34 (FIG. 1) for this purpose. The ordinary sheet without special appliances such as eyelets or an ordinary turn sheet 16 is gripped over a sufficient length to avoid tearing and over a sufficient area to reduce lipping. It is preferably gripped at least at two spaced-apart locations on the ordinary sheet or the turn sheet 16. In this specification, the terms “sheet”, “ordinary sheet”, or “turn sheet” shall include ordinary sheets used to move a patient, turn sheets, draw sheets or any other flexible thin flat material that is used to move a patient using a patient lift or other similar lift.

At the time the end of a turn sheet 16 is initially gripped, the patient 12 should be laying upon the sheet 16. Generally, in nursing homes and in hospitals, an appropriate turn sheet 16 is located on the bed 28 and patients are placed upon it initially if they are not ambulatory. However, this invention is operable even without a typical turn sheet but with an ordinary sheet. The typical turn sheet 16 is of a relatively strong material but may vary in strength at the option of the nursing home or hospital and sheets and turn sheets that are initially strong are weakened with ordinary laundering and use. The patients may also vary in weight being anywhere from a very young small patient to a very obese and heavy patient weighing as much as 800 pounds. A very small patient may be easily handled by staff who are generally required to be able to lift 50 pounds. A patient weighing greater than 50 pounds under some circumstances would be moved with the aid of a lift that would be brought up to the edge of the location where the patient is laying.

While any type of mechanical machine capable of exerting sufficient force capable of gripping the turn sheet 16 may be used, there are standard lifts available in most nursing homes and hospitals for the purpose of lifting the patient. These machines are commonly equipped with a four point attachment location so that a patient may be lifted with stability. However, in the use of this invention, only two such lifting points are required.

To provide sufficient holding power without causing the sheet to slip or tear when lifting, the gripping area of the clip or holder 14A and 14B distributes the tensile force over a sufficiently large length and exerts pressure on the sheet over a sufficiently large area to keep the force per unit of gripping length and the total force below the point where slipping or tearing occurs. One or more gripping apparatus or clips or holders may be used for this purpose. The total area of the gripping apparatus brought to the edge of the turn sheet 16 (FIG. 1) should be sufficient to distribute the tensile force exerted by the lift 18 on the sheet 16 across a sufficient length of the sheet 16 to not cause the fabric to separate under the force necessary to turn the patient which may be as much as 800 pounds. This may be accomplished by a long linear gripping location on one gripping apparatus for the sheet 16 or shorter gripping locations on a plurality of gripping apparatus. In the preferred embodiment, a standard lift is used with two gripping apparatus fastened to it. The gripping apparatus each have enough length for gripping to avoid tearing all but the weakest of turn sheets 16. However, in some institutions, turn sheets 16 may have been degraded by laundering to a point where some tearing may occur even with the longest possible length of gripping on the turn sheet 16.

The gripping apparatus should utilize the greatest possible length orthogonal to the patient so as to distribute the force. The surfaces may be longitudinally straight gripping surfaces or a plurality of points just so the entire length that is pulling in tension along the sheet 16 distributes the force sufficiently to avoid tearing. The length sufficient to avoid tearing during normal patient-repositioning use is referred to as the “tear-resistance length”. In addition to having a sufficient length for pulling to avoid tearing, the gripping apparatus should have sufficient gripping power and area to avoid the sheet 16 from slipping. The force necessary to avoid slipping during normal patient-repositioning use is referred to as the non-slip force with a predetermined lift. One way of accomplishing this is by use of a plurality of parallel narrow ridges on two pinching members of a clip or holder that when forced together will indent the fabric and provide great resistance to slipping. Under most circumstances, this type of force is exerted by a clip type device gripping a fold in the fabric.

It is desirable to grip the fold in the fabric when the turn sheet 16 (FIG. 1) extends a substantial length beyond the patient. Thus, when the gripping apparatus is fastened, it is fastened relatively close to the patient and under some circumstances this is accomplished by folding the turn sheet 16 and gripping adjacent to the fold so that there is a double layer of turn sheet 16 under the clip. When the gripping apparatus are in place with a sufficient area of gripping surface to prevent slipping and a sufficient length to avoid tearing of the sheet 16, the machine used for this purpose is actuated to lift upwardly and move the patient up on one side. The patient may then be supported such as by a pillow in at least one location. Under some circumstances, in locations where the pillow is not located, the machine may be lowered to gain access to the back of the patient when the patient is in a stable position or, if the patient is stably positioned on one side without a support, the lift 18 may be lowered without a propping means. The patient may then be cleaned or the like or bedding placed under the patient as far as permissible up to the side.

The turn sheet 16 is then pulled to lift the patient at least on one side so that access to the patient's back may be obtained. In obtaining access, a pillow or the like may be placed under the patient and the patient lift 18 permitted to lower the gripping apparatus so that the patient may be cleaned or while the patient is in an upward position, the bedding underneath the patient may be changed. The lift 18 may then be moved to the other side to roll the patient up on his or her other side to gain access to another portion of the patient's back. The mechanical device may then be moved to the other side of the bed 28 and the patient rolled on his or her other side to gain access to another portion of the patient and to get underneath the patient at another location. In this manner, access may be gained to the entire back side of the patient.

From the above description, it can be understood that this invention has several advantages, such as: (1) it does not require a special type of turn sheet 16 or the like and can be utilized with the standard draw sheets commonly in use in hospitals and nursing homes; (2) it distributes the force along a sufficient pulling length of a turn sheet 16 to avoid separation of the turn sheet 16 such as by tearing; (3) it sufficiently grips the turn sheet 16 to prevent slipping; (4) it can be used with turn sheets that extend a substantial distance beyond the patient; and (5) it is readily adaptable to any type of turn sheet and to a multiplicity of thicknesses and conditions of turn sheets.

While a preferred embodiment of the invention has been described with some particularity, many modifications and variations are possible in the light of the above teachings. Accordingly, within the scope of the appended claims, it should be understood that the invention may be practiced other than as specifically described.

What is claimed is:

1. A combination, comprising:
a turn sheet;
at least one turn sheet holder;
said at least one turn sheet holder having at least one pair of jaw halves;
each of said jaw halves having a frictional surface;
each of said at least one pair of jaw halves including a corresponding first jaw half and a corresponding second jaw half; and
a lift for moving said at least one turn sheet holder, whereby said at least one turn sheet holder may grip a turn sheet and lift a portion of the turn sheet to move a patient;
each of said at least one turn sheet holder including a corresponding clamping actuator that forces said frictional surfaces together to exert a no slip force on said turn sheet.

2. A combination in accordance with claim 1 wherein each of said corresponding clamping actuators provides sufficient mechanical advantage to force said corresponding first and second jaw halves together sufficient to hold said turn sheet while a patient weighing at least 50 pounds is moved by no more than four turn sheet holders gripping the turn sheet.

3. A combination in accordance with claim 1 wherein said at least one turn sheet holder is adjustable to accommodate different thicknesses of turn sheets.

4. A combination in accordance with claim 2 wherein said at least one turn sheet holder is adjustable to accommodate different thicknesses of turn sheets.

5. A combination in accordance with claim 1 wherein each of said corresponding clamping actuators provides sufficient mechanical advantage to provide non-slip force between said corresponding first and second jaw halves during normal patient-repositioning use.

6. A combination in accordance with claim 1 wherein said lift is able to engage said at least one turn sheet holder and apply enough force to move a patient weighing at least 50 pounds when the turn sheet is held by no more than six turn sheet holders.

7. A combination in accordance with claim 1 wherein said corresponding first and second jaw halves have frictional surfaces that exert force on opposite sides of the turn sheet of fabric, said frictional surfaces applying said force at least at locations sufficiently spaced from each other to avoid tearing of said turn sheet of fabric.

8. A combination in accordance with claim 1 wherein said corresponding first and second jaw halves are biased apart.

9. A combination in accordance with claim 2 wherein said clamping actuator includes a lever.

10. A combination in accordance with claim 9 wherein said lever is self locking.

11. A combination in accordance with claim 9 wherein said lever includes a toggle.

12. A combination in accordance with claim 1 wherein said at least one turn sheet holder has a tear resistance length.

13. A combination in accordance with claim 11 wherein said at least one turn sheet holder comprises two sheet holders.

14. A combination in accordance with claim 1 wherein said at least one turn sheet holder comprises two sheet holders.

15. A combination in accordance with claim 1 wherein a section of said turn sheet between said corresponding first and second jaw halves and said patient is placed in tension; said corresponding first and second jaw halves provide a gripping edge with at least a portion of the gripping edge facing the section of said turn sheet that is placed in tension during moving of the patient; the total length of said gripping edge of said at least one turn sheet holder is sufficiently long so that the force needed to move an 800 pound load is less than the tensile strength of the turn sheet.

16. A combination in accordance with claim 15 in which the total length of said gripping edge is at least 10 inches.

17. A combination in accordance with claim 1 in which the total frictional surfaces are between 10 and 30 inches.

18. A combination in accordance with claim 1 in which the at least one turn sheet holder is connected to the lift by movable means for permitting the at least one turn sheet holder to align with the direction of force.

19. A combination in accordance with claim 1 in which at least one of the corresponding first and second jaw halves have relatively sharp frictional surfaces for holding the turn sheet.

20. A combination in accordance with claim 1 in which the frictional surfaces include elongated ridges.

21. A combination in accordance with claim 20 in which at least some of the elongated ridges are parallel elongated ridges.

22. A holder, comprising:
at least one pair of jaw halves;
said at least one pair of jaw halves including a first jaw half and a second jaw half; and
a clamping actuator for forcing said first and second jaw halves together to exert a no slip force.

23. A holder in accordance with claim 22 wherein said first and second jaw halves each have a different frictional surface that exerts force on opposite sides of a sheet of fabric, said frictional surfaces applying said force at least at locations sufficiently spaced from each other to avoid tearing of said sheet of fabric.

24. A holder in accordance with claim 23 wherein said first and second jaw halves are biased apart.

25. A holder in accordance with claim 22 wherein said clamping actuator includes a lever.

26. A holder in accordance with claim 22 wherein said clamping actuator is self locking.

27. A holder in accordance with claim 22 wherein said lever includes a toggle.

28. An apparatus for moving a patient, comprising:
a flexible flat material having a predetermined strength in tension and a predetermined thickness;
a machine having a gripping apparatus for gripping the flexible flat material at any location on the flexible flat material with a force sufficient to move the patient laying on the flexible flat material without the flexible flat material slipping from the gripping apparatus;
said machine including means for applying a force to the gripping apparatus sufficient to move the patient.

29. An apparatus in accordance with claim 27 in which the machine having a gripping apparatus for gripping the flexible flat material at any location includes a means for gripping a folded portion of the flexible flat material at any location.

30. An apparatus in accordance with claim 28 in which the gripping apparatus is replaceably mounted to the means for applying a force to the gripping apparatus.

31. An apparatus in accordance with claim 28 in which the machine includes a first means for moving the gripping apparatus under sufficient force to turn the patient and a second means for gripping the flexible flat material with sufficient force to prevent slipping of the flexible flat material from the gripping apparatus.

32. An apparatus in accordance with claim 28 in which the gripping apparatus includes:
first and second gripping members and clamping means for forcing the first and second gripping members together;
said first and second gripping members including surfaces for engaging said flexible flat material along a line sufficiently long to distribute the force upon said flexible flat material over a distance of at least eight inches.

33. An apparatus in accordance with claim 32 in which said first and second gripping members are biased apart.

34. An apparatus in accordance with claim 32 further wherein said clamping means imparts sufficient force to said first and second gripping members to prevent said flexible flat material from slipping.

35. An apparatus in accordance with claim 34 in which:
said lever has a fulcrum, a handle section and a pressure section;
said handle section being on one side of said fulcrum and said pressure section being on another side of said fulcrum;
said pressure section being positioned against at least one of said gripping members whereby said handle section moves said pressure section with a force related to the ratio of the length of said handle section to said pressure section about said fulcrum;
said handle section being at least six times the length of said pressure section whereby a mechanical advantage of at least six to one is provided.

36. An apparatus in accordance with claim 32 in which the gripping apparatus includes a plurality of elongated sharp edges facing each other to grip said flexible flat material.

37. A method of turning a patient comprising the steps of:
clamping a turn sheet within at least one clip with a no slip force;
pulling upwardly on said clip with a lift until the turn sheet rolls the patient onto the patient's side.

38. A method in accordance with claim 37 in which the step of clamping a turn sheet comprises the steps of attaching said at least one clip to a lift arm of a patient lift;
folding the turn sheet;
clamping a folded portion of the turn sheet within the at least one clip; and
actuating the lift to pull upwardly on the clip.

39. A method in accordance with claim 37 in which the step of clamping a turn sheet comprises the step of clamping the turn sheet along a tear-resistance length of the turn sheet substantially parallel to the patient.

40. A method in accordance with claim 37 in which the step of clamping a turn sheet includes the step of clamping the turn sheet between a plurality of elongated parallel sharp ridges wherein the force is distributed along at least eight inches of the turn sheet.

41. The method of claim 40 further including the steps of:
lowering a lift arm after the patient has been rolled onto one side;
releasing the at least one clip;
moving the lift to the other side of a bed;
clamping a fold of the turn sheet within the at least one clip; and
lifting upwardly on the at least one clip so as to roll the patient back into position.

42. The method of claim 40 wherein the lift has two spaced apart clips attached to its lift arm.

43. The method of claim 42 wherein the clips are clamping devices that can clamp the turn sheet within a jaw that has sufficient holding power to turn a patient.

44. The method of claim 43 wherein the turn sheet is folded at a location close to the patient clamped in the clips and then the lift is actuated to roll the patient onto the patient's side without the use of any special turn sheets.
